(19) United States
(12) Patent Application Publication
(10) Pub. No.: US 2008/0072466 A1
(43) Pub. Date: Mar. 27, 2008

(54) APPAREL INSERT WITH MOUNT

(76) Inventor: Larry Fenner, Ferndale, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/858,792

(22) Filed: Sep. 20, 2007

Related U.S. Application Data
(60) Provisional application No. 60/846,132, filed on Sep. 21, 2006.

(51) Int. Cl. G09F 3/16

(52) U.S. Cl. 40/329; 40/586; 40/636; 40/666

(57) ABSTRACT

An article of clothing insert system which has a perimeter mounting member which is configured to have inserts be positioned therein and mounted on articles of clothing. The inserts can be replaceable by way of positioning therein an annular recess portion.

### RELATED APPLICATIONS

This application claims priority benefit of U.S. Ser. No. 60/846,132, filed Sep. 21, 2007.

### BACKGROUND OF THE DISCLOSURE

While many clothing items have been disclosed in the prior art in various forms, there is no teaching for providing an insertable member into clothing items which can be inserted in various forms by way of a perimeter mounting member and which can be retrofitted to clothing lines or specific articles of cloth, such as a hat.

### SUMMARY OF THE DISCLOSURE

Disclosed herein is a clothing insert system wherein an article of clothing is provided and a surface defining an opening is created within a portion of the article of clothing. This surface defining an opening has a perimeter portion which may be a circle, square, symbol, or any other geometric design. An insert member is also provided which in one form is a disk having an upper surface, a lower surface and an insert perimeter region. A mounting member is also disclosed which in one form is similar in some respects to a grommet. The mounting member has an outer perimeter region, and an inner perimeter region, and may be substantially in shape of a circle, square, logo, symbol, or other geometric design. The outer perimeter region of the mounting member has an outer annular-recessed portion with an inner surface. This inner surface of the outer annular-recessed portion approximately conforms to the shape of the opening provided in the article of clothing. The inner perimeter region of the mounting member has an inner annular-recessed portion with an inner surface. This inner surface of the inner annular-recessed portion approximately conforms to the shape of the perimeter region shape of the insert member. In one form, the mounting member is created of a malleable material such that it can deform and be press-fit into the surface defining an opening in the article of clothing. The outer annular-recessed portion of the mounting member further comprises first and second overlap regions extending substantially around the perimeter portion of the mounting member. In one form the mounting member is formed of a malleable material such that the mounting member can be placed adjacent to the service defining an opening in the article of clothing and press fit into the surface defining an opening in an article of clothing such that one of the overlap regions deforms past the opening and reforms such that the first and second overlap regions are adjacent to the first and second surfaces of the article of clothing. For example, if the mounting member is placed within an opening of the bill of a hat, the first overlap region would be adjacent upper surface of the bill of the hat and the second overlap region would be adjacent to the lower surface of the bill of the hat. The aforementioned outer perimeter region substantially conforms to the inner perimeter region of the surface defining an opening provided within the article of clothing.

In one form, the first and second retaining surfaces are substantially parallel to each other, and extend within the immediate plane of the article of clothing near the outer perimeter region of the mounting member.

An insert member may also be provided having an insert perimeter region which generally conforms in thickness and in shape to the aforementioned inner perimeter region of the mounting member. In this form, the insert member may be press fit within the first and second overlap region extending substantially within the inner perimeter region of the mounting member. This configuration operates to retain the insert member within the mounting member.

In one form, the insert member provided comprises a transparent portion, configured to partially allow light to pass therethrough. In this way, the shadow or image of a logo disposed upon the insert member would be projected upon another surface such as a wearer's skin surface possibly on their face.

The insert member of one form has a circular profile, although other profiles can also be used such as squares, symbols, logos, or other geometric designs.

In one form, the mounting number is a unitary structure made of a pliable material with a durometer value between 60 and 85. Alternatively, the mounting member may be a multiple part structure with a similar durometer value, configured to engage the first and second surface portions of the article of clothing. For example, the mounting member may be formed of a plurality of ring-like elements which are placed adjacent the first and second surfaces of an article of clothing and press fit or otherwise coupled together. This may be accomplished by way of a snap-fit construction, adhesive, screws, or other attachment methods.

As in one form the insert member is easily removed from the mounting portion, a plurality of insert members configured to be interchangeably placed and held by the mounting member may be provided. For example, during football season the user may display a logo representing their favorite football team, and during the baseball season, the user may display a logo of their favorite baseball team.

Where the perimeter mounting member is comprised of first and second mounting sub-members, the first retaining surface of the inner annular recessed portion may be a part of the first sub-member and the second retaining surface of the inner annular-recessed portion is a part of the second sub-member. In another form, the first and second sub-members are engaged to one another to fit the approximate cross-sectional opening of the article of clothing by way of ridges and grooves forming threads. In this form, the first and second sub-members may be screwed together. Alternatively, the first and second sub-members may be frictionally engaged with one another such as a snap-fit or possibly including the use of adhesive. Where the profile sub-members are not threaded or screwed together, the inner annular-recessed portion may be a shape other than a circle as previously discussed.

While previous discussions of this disclosure has been related to the use of the clothing insert system upon the bill of a hat, the same apparatus and method can be utilized to couple the insert member to alternate articles of clothing, apparel, or elements such as footwear, jackets (or other upper body garments), pants, backpacks, luggage, purses, and other elements.

### BRIEF DESCRIPTION OF THE DRAWINGS

FIG. 1 shows an environmental view of an article of clothing insert system positioned upon an article of clothing, such as the bill of a hat, positioned on an individual where in one form a partially translucent insert member allows light to pass therethrough to depict an image upon the individual;

FIG. 2 shows an isometric view of one form of a perimeter mounting member;

FIG. 3 shows a top view of a perimeter mounting member;

FIG. 4 shows the profile view of one form of a perimeter mounting member illustrating the outer perimeter regions and the annular recessed portion thereof;

FIG. 5 shows an exploded view of another form of a perimeter mounting member with an insert member interposed between the two subassemblies;

FIG. 6 shows one of the subassemblies of the perimeter mounting members where a female threaded region is positioned therein;

FIG. 7 shows an exploded view of another embodiment of a snap fit type assembly;

FIG. 8 shows the inside portion of a snap fit type subassembly;

FIG. 9 shows an isometric view of another form of upper and lower transverse regions of the perimeter mounting member;

FIG. 10 shows a profile view of a perimeter mounting member;

FIG. 11 shows another form of a perimeter mounting member;

FIG. 12 shows a profile view of the perimeter mounting member of FIG. 11;

FIG. 13 shows an isometric view of a textured form of a perimeter mounting member;

FIG. 14 shows a profile view of the textured form of the perimeter mounting member;

FIG. 15 shows an isometric view of a perimeter mounting member with a non-circular cross-sectional area such as the shape of a heart for exemplary purposes;

FIG. 16 shows a profile view of the perimeter mounting member of FIG. 15;

FIG. 17 shows another example of a non-cylindrical profile view of the transverse direction of the perimeter mounting member;

FIG. 18 shows a profile view of the perimeter mounting member of FIG. 17;

FIG. 19 shows an exploded isometric view of another form of an attachment system;

FIG. 20 shows a lower sub-member of a garment attachment mechanism;

FIG. 21 shows a profile view of the member of FIG. 20;

FIG. 22 shows an upper member having a recess region configured to engage the annular transverse extension as shown in FIG. 20;

FIG. 23 shows another embodiment where fasteners are utilized to assemble the garment attachment system;

FIG. 24 shows a profile view of the attachment fasteners as well as the lower attachment sub-member;

FIG. 25 shows the upper attachment member of the assembly of FIG. 23;

FIG. 26 shows an isometric view of another form of a garment attachment perimeter member where interposing cross-sectional member(s) are utilized;

FIG. 27 shows a top view of the embodiment of FIG. 26;

FIG. 28 shows another operating environment for the insert system which in one form can be mounted to footwear.

### DESCRIPTION OF THE PREFERRED EMBODIMENTS

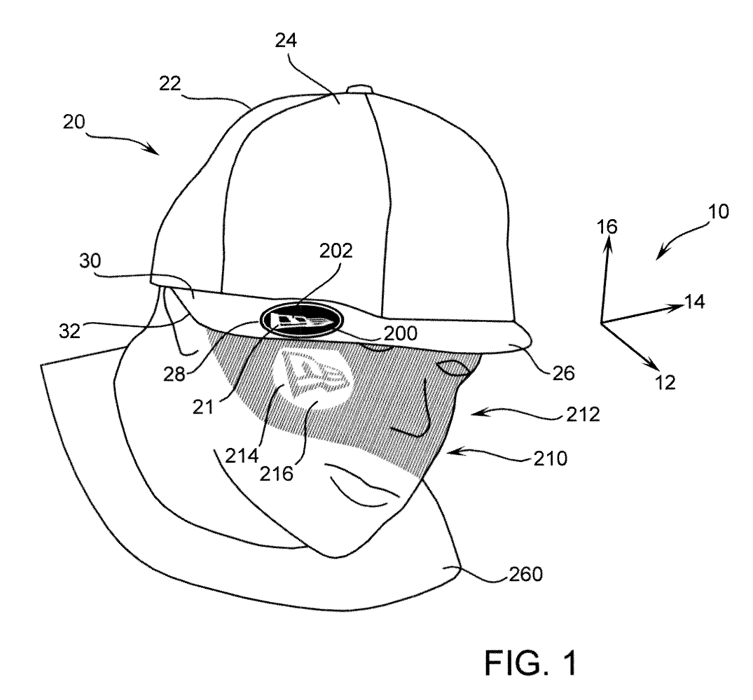

Disclosed herein is a clothing insert system which is described in detail to show one form of carrying out the preferred disclosure. In general, it may be desirable to display certain logos of personal affection or appreciation upon one's own body. In one form, these logo insert members can be interchangeable to reflect one's own personal decision to display a logo member on their own personal article of clothing, such as a hat, upper body garment, pants, or footwear. As described herein, there is a system for providing a perimeter mounting member which is also referred to as a grommet member, configured to retain an insert member. In one form, as shown in FIG. 1, the insert member can be translucent or partially translucent such that light passing through the insert member can form a shape, logo or other specified image of interest which can be thereupon depicted on the individual. Further, the insert member can be interchangeable and indeed not be necessarily translucent. In one form, the perimeter mounting member, which is an interface between the insert member and the article of clothing, can have inner and outer annular recessed portions for fitting insert members upon the articles of clothing. In one form, the perimeter mounting member can be made of a pliable material of, for example, a durometer rating between 60 and 85 in the broader range, which allows for first and second retaining surfaces of the annular recessed portion to be repositioned to refit the insert member in the inner perimeter region. In other forms described herein, the perimeter mounting member can be comprised of a two-piece design having sub-members which can be threadedly attached to comprise a circular profile of a grommet, or fractionally attached by way of fasteners such as screws. Of course other forms of fixing the two members could be utilized.

Now referring to FIG. 1, there is shown the clothing insert system 20 mounted to the bill region of a hat.

As shown in FIG. 1, the axes system 10 is comprised of a longitudinal axis 12 indicating a forward direction where the opposing direction is the rearward longitudinal direction. The axis 14 indicates a lateral direction and the axis 16 indicates a vertical direction.

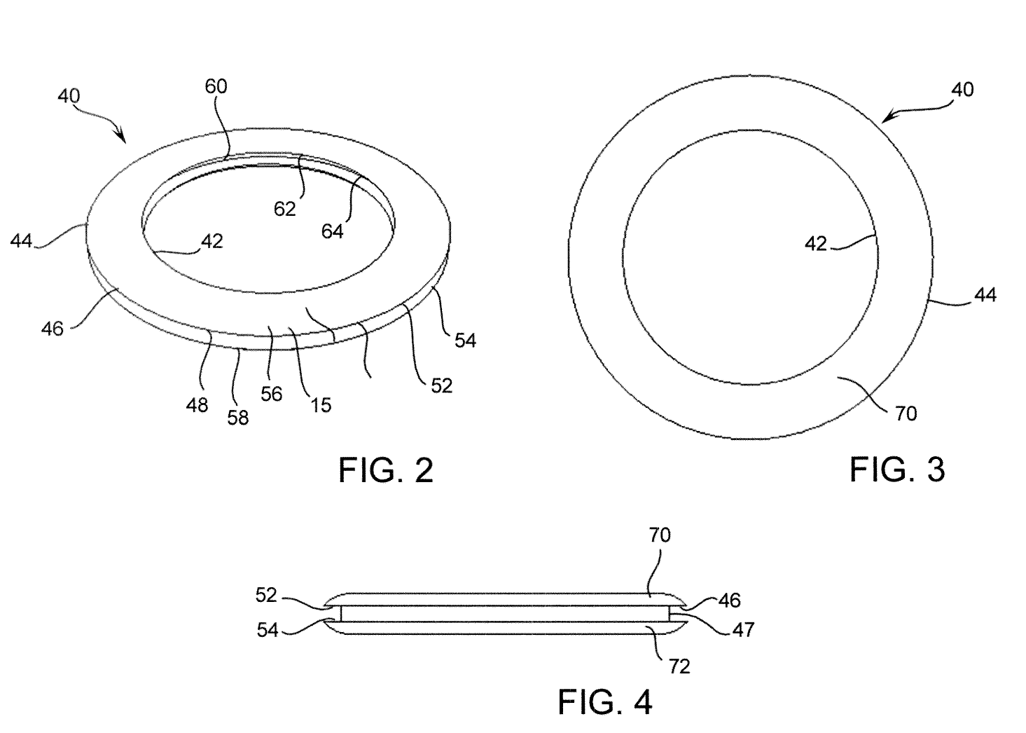

As is further shown in FIG. 1, there is an article of clothing 22 which in one form is a hat. In this form, the base portion 24 is attached to a bill region 26. The article of clothing 22 has a surface defining an opening indicated at 28. Further, the surface has a perimeter region and first and second surface portions generally indicated at 30 and 32. The surface portions are substantially opposing one another and positioned around the perimeter region of the opening 28. In one example, the surface 30 is the upper surface of the bill of a hat, and the surface 32 is the underside of the bill of a hat. In one form, the article of clothing can be stamped or otherwise cut to remove a portion thereof in a predefined shape. In one form, the opening is a circular; however, other types of openings can be employed for different types of insert systems such as perimeter mounting members which are described further herein. Now referring to FIG. 2, there is shown a perimeter mounting member similar to a grommet.

In general, this member can be of a unitary structure or a two-piece structure as described later herein. In general, the perimeter mounting member 40 is comprised of an inner perimeter region 42 and an outer perimeter region 44. Positioned along the outer perimeter region is an annular recessed portion 46. This annular recessed portion 46 comprises an inner surface which forms an annular groove around the perimeter region. In one form, the groove is continuous.

In one form, the durometer rating of the mounting member 40 can range between 25 to 100 on the Shore Scale A′ in the broader range on a shore scale rating and may be comprised of a urethane, or elastic product. In a more preferred range, the durometer rating can be between 50 and 80. The desirable durometer rating is approximately 60, plus or minus 10%. Of course, the durometer rating depends upon the thickness of the inner portion of the mounting member 40, and a thinner mounting member 40 between 1 and 3 millimeters may have a higher durometer rating, and a thicker member between 1.5 and 5 millimeters may have a lower durometer rating in the lower end of the various scales described above. The molding process for the perimeter mounting member can be accomplished with a high-pressure injection molding using tool steel molds or the like, or it can be formed by other means such as machined from wood, aluminum, or the like.

Further, a low pressure vented mold can be utilized in such a process. In one form a psi injection occurs, thereby pouring the compound within a mold to allow the air to escape and form the perimeter mounting member in one form. With other material such as wood or metal or plastic perimeter members, as described further herein, other types of attachment mechanisms can be used to form a perimeter mounting member in, say, a two-piece design, or possibly more than two pieces. The surface 48 has an innermost surface and is also comprised of first and second substantially opposing retaining overlap regions 52 and 54, which are formed by the first and second overlap regions 56 and 58.

The inner perimeter region 42 has an inner annular recessed portion 60 which is comprised of first and second retaining surfaces 62 and 64. The surfaces 62 and 64 in one form substantially oppose one another, and further, at least one of the surfaces can have sufficient flexibility to allow the insert member 21 to be positioned therein (see FIG. 1).

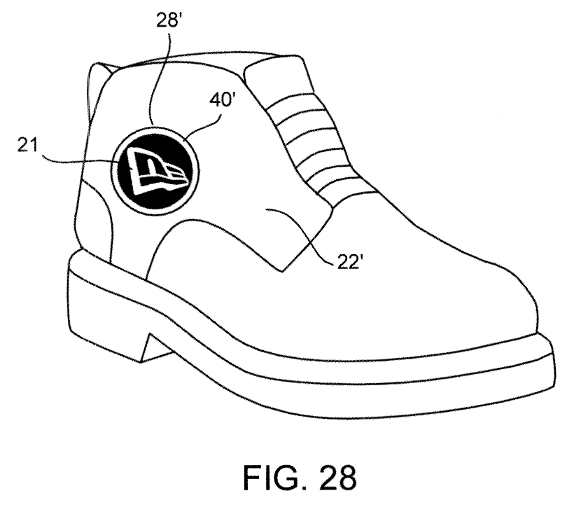

FIG. 3 shows a top view of the perimeter mounting member 40 and FIG. 4 illustrates how the perimeter mounting member can be comprised of regions defined as first and second transverse regions 70 and 72 (see FIG. 4). The outer annular recessed portion 46 is shown in FIG. 4 where the inner surface 47 can engage the inner region of the perimeter portion of the opening 28 of the article of clothing 22 as shown in FIG. 1. The first and second substantially opposing retaining surfaces 52 and 54 are shown best in FIG. 4, and operate in a manner so as to retain a perimeter mounting member to the article of clothing 22 as shown in FIG. 1 and FIG. 28 described further herein.

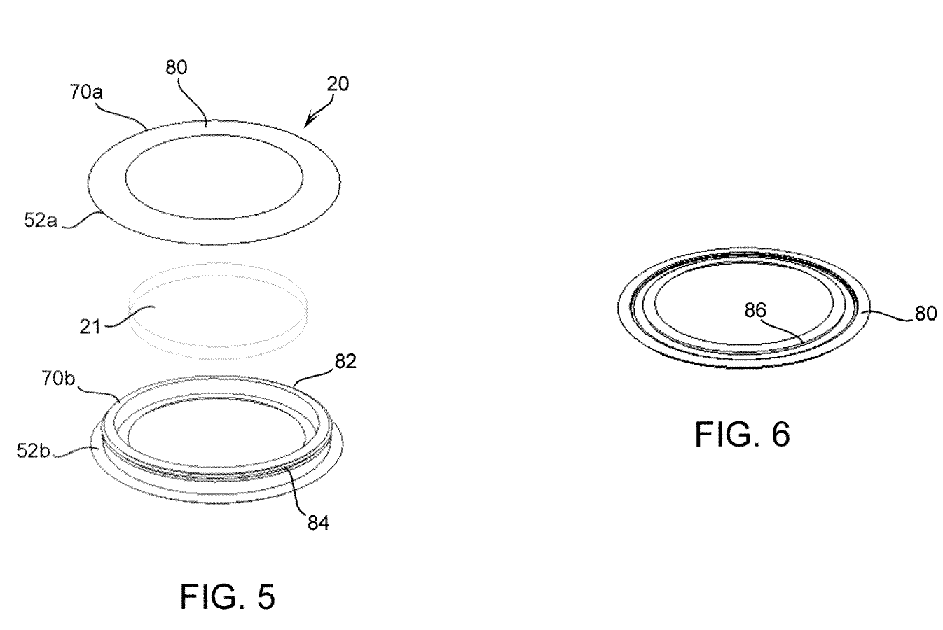

Now referring to FIG. 5, there is shown another embodiment where the first and second transverse regions 70A and 70B are shown as separate structures which are referred to as perimeter mounting sub-members 80 and 82. In this form, an insert member 21 can be interposed therebetween, and these sub-members 80 and 82 are configured to interpose the insert member 21 between the surfaces 52A and 52B. The annular portion 84 can be a snap fitting or a threaded engagement which is configured to fit within the annular recess 86 (see FIG. 6) which can either be a female threaded portion or a snap-type fitting. The insert member 21 is therefore interposed between the sub-members 80 and 82 when fitted to the article of clothing 22 within the surface defining an opening 28 as shown in FIG. 1.

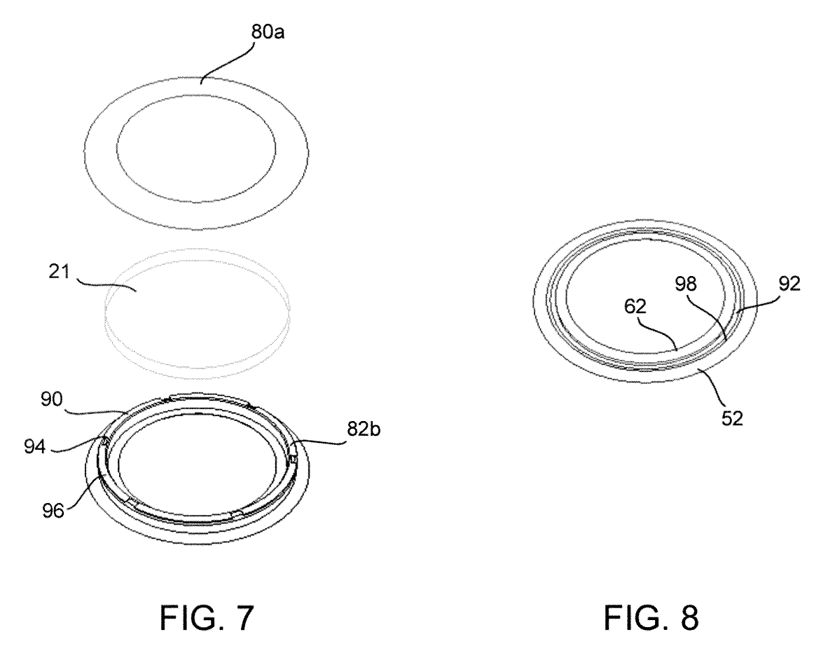

Now referring to FIG. 7, there is shown another form of a snap-type fitting. In this form the region 90 is operatively configured to engage a slotted recessed portion 92 as shown in FIG. 8. The region 90 can be fitted with openings 94 to provide structural flexibility thereof so the engagement portions 96 having the outer flange member are configured to engage within the flange recess 98 as shown in FIG. 8. This embodiment involves a fitting which can be mechanically snap-fit or further secured in place with an adhesive, or instead of a snap-fit there can be provided an adhesive to secure the two sub-members 80A and 80B. In a similar form as the previous embodiment, the insert member 21 is interposed therebetween.

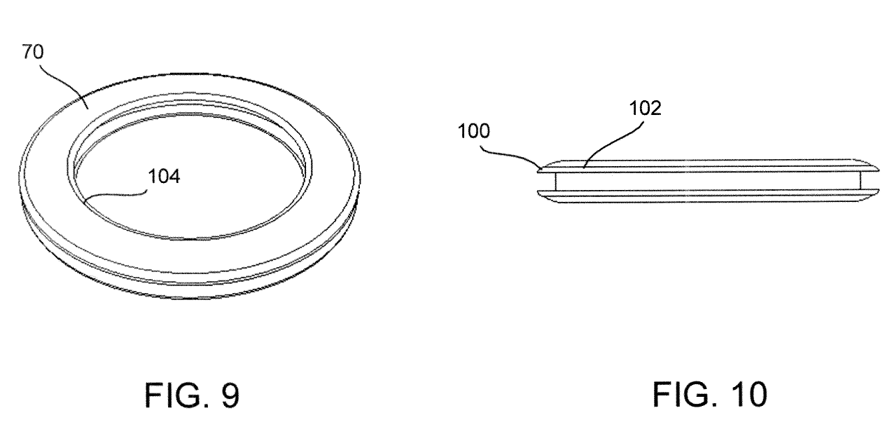

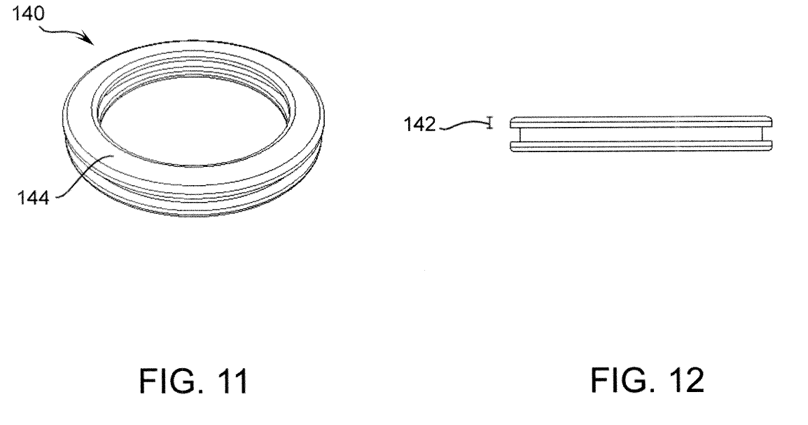

FIG. 9 shows another form where the first transverse region 70 has a wider cross-sectional profile so as to reduce the stress rise in the outer perimeter region 100 as shown in FIG. 10. Of course a number of cross-sectional profiles as shown in FIG. 10 can be employed. In one form, the outer annular portion 102 can be strengthened to reduce the possibility of compromising the structure around this region. As shown in FIG. 9, the inner region 104 can further be a strengthened to reduce the possibility of damaging the structure. The following figures show various embodiments that can additionally be utilized. FIG. 11 shows another form where, the perimeter mounting member 140 is shown with a raised profile. The profile has a height dimension indicated at 142 (see FIG. 12) which can be raised for aesthetic appearance or for structural integrity. In one form, a plurality of materials can be used to comprise the perimeter mounting member. The upper surface indicated at 144 can be utilized for disposing text or other symbols or graphic depictions thereupon. Further, in a more substantial embodiment as shown in FIGS. 11 and 12, the perimeter mounting member can be made of other material such as wood or the like.

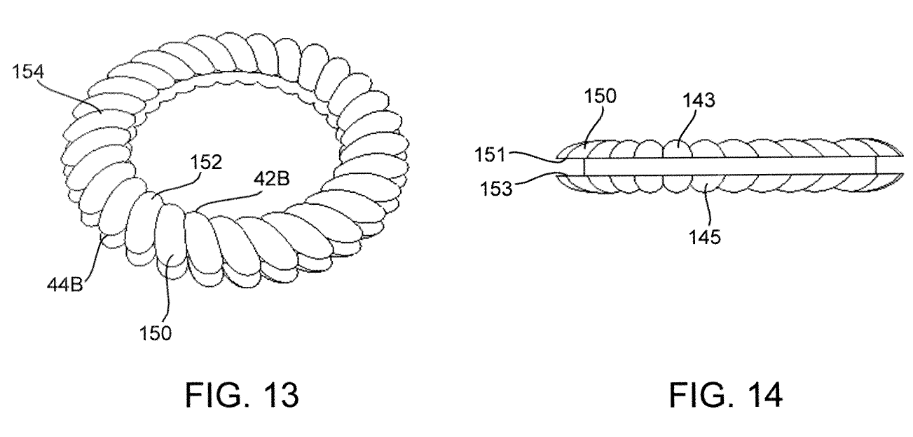

FIGS. 13 and 14 show an alternative embodiment where, for example, the perimeter regions in the transverse direction are ornamental in design and the members can be slight extension members indicated at 150 which are extending in a circular direction but not in a perfect circular profile. In a similar form, the inner extensions 152 can extend in a radially inward direction. This type of arrangement can be such that the tactile feel of the upper surface 154 can be due to a variety of molded or machine types of surfaces. The inner and outer perimeter regions 42B and 44B are configured to engage the insert member 21 and the article of clothing 22 respectively. As shown in FIG. 14, the upper and lower regions 143 and 145 are positioned as such so the first and second surfaces 151 and 153 are sufficiently extended in a radially outward direction to engage the article of clothing.

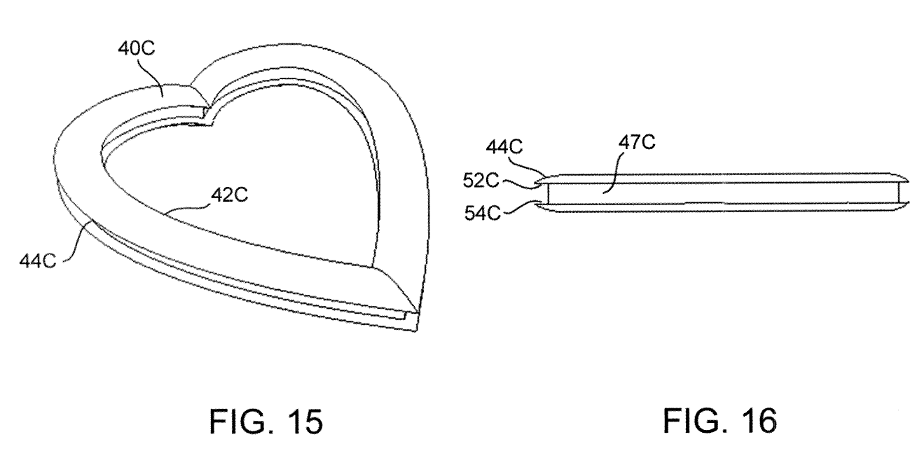

Now referring to FIGS. 15-18, there are other forms where different cross-sectional profiles are utilized. FIG. 15 shows a cross-sectional profile of the perimeter mounting member 40C which in this form resembles a heart. Other shapes are also equally effective, including but not limited to animals, logos, symbols, letters, and geometric shapes. The inner and outer perimeter regions 42C and 44C are configured to allow for inner and outer annular groove portions. As shown in FIG. 16, the first and second surfaces 52C and 54C extend substantially around the perimeter to engage an article of clothing. In this form, the article of clothing can have an opening which substantially conforms to the surface 47C, and there can be a tight engagement to the surface 47C or the surfaces 52C and 54C can be in close enough proximity to tightly engage the first and second surfaces 30 and 32 (see FIG. 1) of the article of clothing.

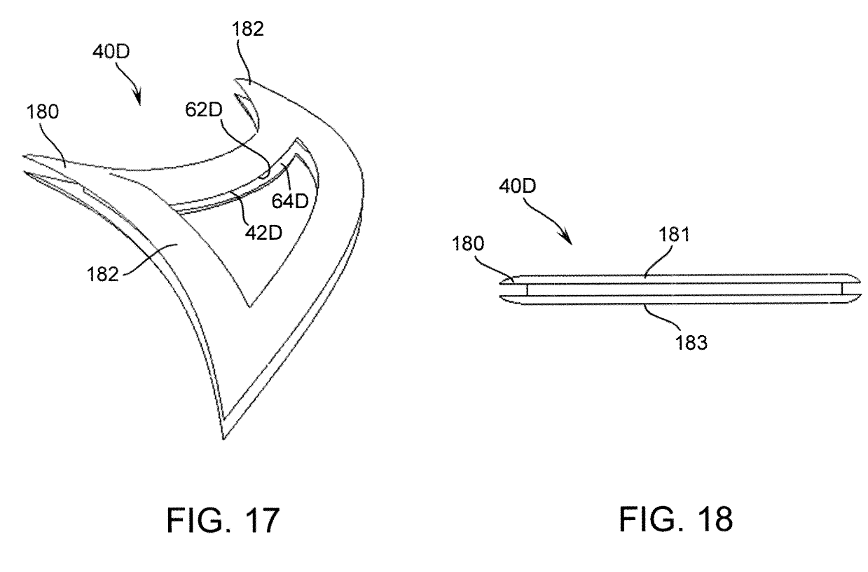

Now referring to FIGS. 17 and 18, there is shown another perimeter mounting member 40D which has another unique cross-sectional profile. In this form, the cross-sectional profile can have extension members 180 which extend therebeyond in a direction to provide additional design features. For example, the extensions 180, 182 and 184 can have an extended annular groove region to mount to the article of clothing. Further, an adhesive can be utilized to further secure these regions to the article of clothing. FIG. 18 shows the member 40D constructed such that the extension region 180 can extend a greater amount around the article of clothing. In one form, the inner perimeter region 42D is constructed in a manner so the first and second retaining surfaces 62D and 64D may be shallower in depth when encompassing the outer perimeter region of an insert. It should further be noted that the upper surface 181 and the lower surface 183 shown in FIG. 18 can have matter imprinted thereupon.

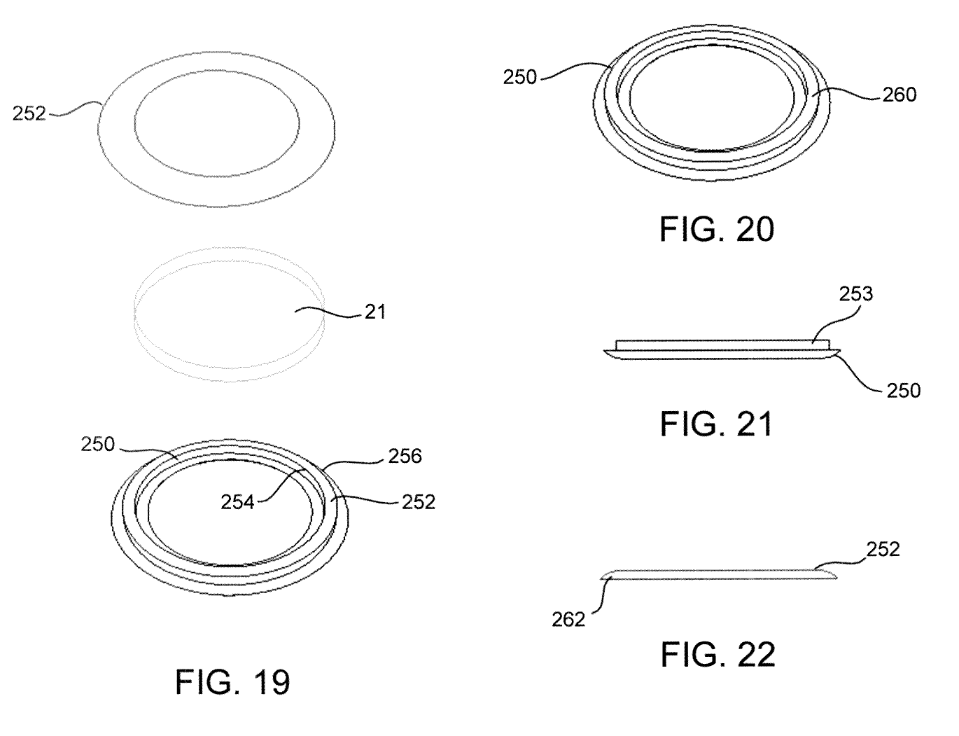

Now referring to FIG. 19, there is shown one example of another article of clothing 22′ where the perimeter region indicated at 28′ in this form is configured to fit upon a region of an article of footwear, such as a boot or shoe. In this form, the insert member 21 is positioned therein and fitted to the perimeter mounting member 40′. In one form, the article of clothing could be double layered such that an outer layer has a portion thereof removed and an inner layer provides a protective coating, such as a waterproof seal. Of course other articles of clothing could be utilized as well, such as legwear and upper body garments.

Now referring to FIG. 1 there is shown the insert member 21 where the insert member 21 in one form is a translucent like member. FIG. 5 shows an insert member 21 which is schematically shown as a clear member. It should be noted that the insert member 21 having the upper surface 200 and a lower surface can have either etched translucence or ink-imprinted translucence thereon. Alternatively, the insert member can be nontransparent and have a image from a symbol wording or other type of depiction graphic depiction. FIG. 1 shows one unique method where the insert member has a powerful translucence and an image 202 which can be a trademarked image is imprinted or otherwise placed upon the insert member 21. In this form, the insert member has a varying translucence which alters the light transmitted therethrough by way of the degree of intensity of the light or the frequency range of the light, meaning the colors that pass therethrough. The individual 210 having in this case a head region 212 with a skin surface 214 can have the image 216 projected upon, for example, the cheekbone surface 214 of his or her face. In other words, in one form, ambient light such sunlight, light bulb illumination, or other forms of light can pass through a portion of the insert member 21 and print a version of a logo, wording or other type of image 216 upon the user's skin surface 214, clothing, or elsewhere. Of course, other forms of images can be transmitted, and in one form, the image 202 can have an altered dimensions (in this case the reduced longitudinal direction) so it is depicted upon the user's face for a given range of angles with respect to the angle of light incident upon the insert member 21. In other words, with the angle of a light source such as the sun, of a range of between 200 from vertical to 40° from vertical, there can be an altered image which is slightly shortened in the longitudinal direction 12 to depict a more proper proportion at 216 when fight reproduces the image upon the individual 210.

FIGS. 19-22 shows another embodiment which can either be a frictional-type fit arrangement or an adhesive attachment system. In general, the lower member 250 is configured to attach to the upper member 252 with the insert 21 interposed therebetween. The annular extension 253 extends in the transverse direction and supplies the inner and outer radial surfaces 254 and 256. FIG. 21 shows a profile view of the extension member 253 and FIG. 20 shows an enlarged view of the lower member 250 where the thickness indicated at 260 can be of varying radial dimensions. FIG. 22 shows a profile view of the upper member 252 where a recess portion at the annular region indicated at 262 is positioned therearound to either frictionally or adhesively fit therein.

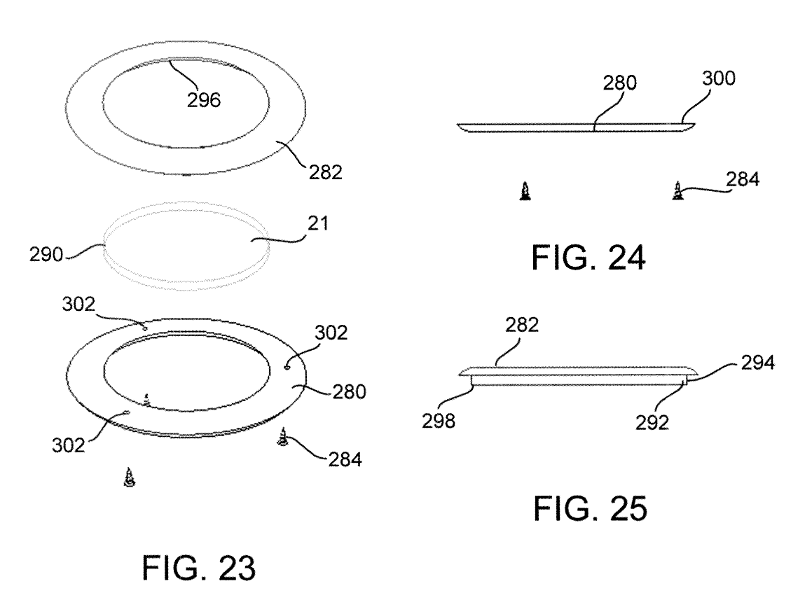

FIGS. 23-25 show other forms where a mechanical attachment system can be utilized such as screws 284. As show in FIG. 23, there is an exploded view where the first and second members 280 and 282 comprise the attachment portions. A plurality of fasteners 284 can be utilized which in one form are threaded screws. Of course, other types of fasteners could also be employed. In one form of the insert member 21, the outer surface 294 can operate as the inner annular surface of the attachment mechanism to the article of clothing. Alternatively, as show in FIG. 25, there can be an annular extension 292 having an outer surface 294 and an inner surface positioned therein and shown in part in FIG. 23 at 296, which is configured to have the outer surface 290 of the insert member fit therein. The lower surface 298 of the transverse second member 282 can be configured to be positioned adjacent to the surface 300 of FIG. 24. Of course, the surfaces defining the openings 302 as shown in FIG. 23 are configured to allow the fasteners 284 to pass therethrough and the surface 298 of FIG. 25 is configured to have openings which threadedly receive the fasteners 284 when screws are used. Alternatively, wood screws or the like could be utilized to screw into the member 282.

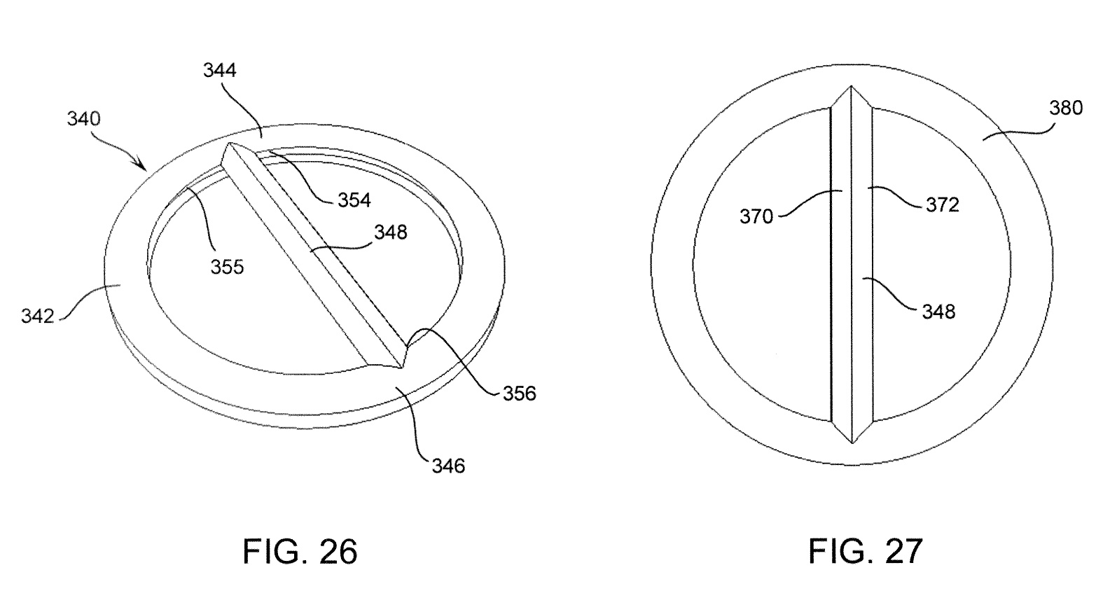

FIGS. 26-27 show yet another embodiment of the perimeter attachment portion where, for example, the portion can have interposing regions spanning the central open area. As shown in FIG. 26, there is an isometric view showing a perimeter attachment member 340 which is comprised of an annular region 342, and at the regions 344 and 346 there is an opposing attachment portion 348. In one form this member can be sufficiently flexible such that an insert can be positioned in the open regions 350 and 352, and may slide around the portions 354 and 356 to be fit within the inner annular recess portion 358. FIG. 27 shows a top view where, in one form, the portion 348 can be formed in different designs. For example, there are two planar regions 370 and 372, and as noted in previous discussion, this center member 348 can be one of many center members and could be even be a rigid multiple-part type of design as. Further, the regions 370 and 372 have surfaces which can have text logos, symbols or other images imprinted thereon, and of course the perimeter region indicated at 380 can further have such a type of indicia imprinted thereon.

The outer annular member could be reinforced with other attachment methods, such as sewing or the like. The outer annular portion is defined as having first and second opposing services, at least in part, which help keep the retaining member 40 in place. It should also be noted that the information printing on the rings and inserts can be accomplished with a plurality of methods, such as silk screen, color injection in the mold, heat transfer process, sewing, laser printing etching, painting with different compositions, and other methods of image transfer thereto.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A clothing insert system comprising:
a. an article of clothing comprising a surface defining an opening having a perimeter portion;
b. an insert member comprising a profile defined by an insert perimeter region;
c. a mounting member comprising an outer perimeter region and an inner perimeter region, the outer perimeter region comprising an outer annular recessed portion with an inner surface approximately conforming to the surface defining the opening of the article of clothing, the outer annular recessed portion comprising first and second overlap regions extending substantially around the perimeter portion of the surface defining the opening of the article of clothing, the inner perimeter region of the mounting member further comprising an inner annular recessed portion with first and second retaining surfaces that are substantially opposed to one another and the first and second retaining surfaces being comprised of a sufficiently flexible material to have the insert perimeter region fitted therearound such that the insert perimeter region fits within the inner annular recess of the mounting member to be held therein.

2. The clothing insert system as recited in claim 1 where the first and second retaining surfaces are substantially parallel and extend within the immediate plane of the article of clothing near the outer perimeter region of the mounting member.

3. The clothing insert system as recited in claim 1 where the insert member further comprises a transparent portion configured to partially allow light to pass therethough.

4. The clothing insert system as recited in claim 3 where the article of clothing is comprised of a bill portion of a hat where the surface defining the opening within the hat comprises a mounting member positioned therein, and positioned in a manner such that light passing through the insert member is projected toward an individual wearing the hat.

5. The clothing insert system as recited in claim 4 where the translucence of the insert member is nonuniform, thereby creating a pattern on the insert member such that light passing through the insert member projects an image upon the individual wearing the hat.

6. The clothing insert system as recited in claim 1 where the insert member has a circular profile.

7. The clothing insert system as recited in claim 1 where the mounting member is a unitary structure made of a pliable material with a durometer value between 60 and 85.

8. The clothing insert system as recited in claim 1 where the mounting member is a multi-part structure configured to engage the first and second surface portions of the article of clothing.

9. A clothing insert system configured to fit upon an article of clothing comprising opposing first and second surface portions of the article of clothing and a surface defining an opening thereupon, the clothing insert system comprising:
a. a perimeter mounting member comprising:
i. an annular recessed portion positioned at an outer perimeter region, the annular recessed portion operatively configured to engage the first and second surfaces of the article of clothing adjacent to the surface defining the opening formed upon the article of clothing,
ii. an inner annular recessed portion comprising first and second retaining surfaces,
b. an insert member comprised of a perimeter region, the perimeter region comprising first and second substantially opposing annular surface regions, the first and second substantially opposing annular surface regions configured to engage the first and second retaining surfaces of the inner annular recessed portion of the perimeter mounting member, thereby configured to maintain the position of the insert member within the surface defining an opening formed upon the article of clothing.

10. The clothing insert system as recited in claim 9 where the perimeter mounting member is a unitary structure which is configured to fit in place upon the article of clothing by deforming the natural cross-sectional area of the perimeter mounting member such that the annular recessed portion is positioned to engage the first and second surfaces of the article of clothing.

11. The clothing insert system as recited in claim 10 where the insert member is operatively configured to fit within the inner annular recessed portion by deforming either the first or second retaining surfaces whereby the first or second retaining surfaces are sufficiently flexible to be positioned around the perimeter region of the insert member to fixedly and removably hold the insert member upon the article of clothing.

12. The clothing insert system as recited in claim 11 further comprising a plurality of insert members configured to be interchangeably placed and mounted to the perimeter mounting member.

13. The clothing insert system as recited in claim 11 where the insert member is at least partially translucent, allowing light to pass therethrough, and the article of clothing is the bill portion of a hat where the insert member has a symbol thereupon which is configured to cast an image upon an individual wearing the article of clothing.

14. The clothing insert system as recited in claim 9 where the insert member is permanently attached to the mounting member.

15. The clothing insert system as recited in claim 9 where the perimeter mounting member is comprised of first and second mounting sub-members where the first retaining surface of the inner annular recessed portion is a part of the first sub member and the second retaining surface of the inner annular recessed portion is a part of the second sub member.

16. The clothing insert system as recited in claim 15 where the first and second sub members are engaged to one another to fit the approximate cross-sectional opening of the article of clothing by way of ridges and grooves forming threads.

17. The clothing insert system as recited in claim 15 where the first and second sub members are frictionally engaged with one another.

18. The clothing insert system as recited in claim 17 where the cross-sectional profile of the inner annular recessed portion is not circular.

19. The clothing insert system as recited in claim 18 where the frictional engagement between the first and second sub members is incurred through adhesive.

20. The clothing insert system as recited in claim 9 where the insert member is configured to attach to footwear by way of the perimeter mounting member.
